(19) United States
(12) Patent Application Publication
(10) Pub. No.: US 2024/0139844 A1
(43) Pub. Date: May 2, 2024

(54) ELECTRODE FOR PULSED ELECTROCHEMICAL MACHINING

(71) Applicant: Rolls-Royce Corporation, Indianapolis, IN (US)

(72) Inventors: Monica Sy Munoz, Indianapolis, IN (US); Damon Ward, Indianapolis, IN (US); Rusty M. Garner, Indianapolis, IN (US)

(21) Appl. No.: 18/051,237

(22) Filed: Oct. 31, 2022

(51) Int. Cl. B23H 3/06; B23H 7/24; B23H 7/32

(52) U.S. Cl. CPC B23H 3/06; B23H 7/24; B23H 7/32; B23H 2300/12

(57) ABSTRACT

In some examples, pulsed electrochemical machining (pECM) system, including an pECM tool comprising a tool body, the tool body comprising an electrode defining a working surface configured to oppose a workpiece during a pECM process; an electrolyte system configured to supply electrolyte to an interelectrode gap between the working surface of the electrode and a target surface of the workpiece; and a power supply configured to generate a pulsed direct current between the one or more electrodes of the pECM tool and the workpiece during the pECM process. The electrode includes an oxidation resistant layer defining at least a portion of the working surface, and a diamond-like carbon coating that defines another surface of the electrode.

### TECHNICAL FIELD

The disclosure relates to pulsed electrochemical machining (pECM).

### BACKGROUND

Machining processes may involve removal of material from a workpiece to form a component having a finished shape and texture. Pulsed electrochemical machining (pECM) is a non-contact machining process based on the principles of electrolysis. Pulsed electrochemical machining may also be referred to as precision electrochemical machining or pulse electrochemical machining. A pECM system may include a tool (the cathode) that imparts its shape into a workpiece (the anode) in a mirror image. As the tool moves toward a surface of the workpiece to be machined, a pulsed DC current may be applied to the tool and the workpiece. The tool maintains a tiny interelectrode gap (e.g., of less than about 10 microns) from the surface of the workpiece, and the workpiece dissolves anodically about the tool, taking on the complementary shape of the tool. An electrolyte pumped between the tool and the workpiece may remove dissolved metal from the workpiece and heat.

Since the cathodic tool does not physically contact the anodic workpiece, pECM can produce burr-free three-dimensional shapes with little or no tool wear. pECM may be used to machine any conductive metal or alloy, and is particularly well suited for materials, such as superalloys, that are difficult to machine through conventional methods. Materials commonly machined with pECM include, for example, nickel, iron, and titanium-based alloys in a variety of formats such as cast (including single crystal), forged, additively manufactured, and powdered metallurgy.

### SUMMARY

In some examples, the disclosure directed to a pulsed electrochemical machining (pECM) system, comprising: an pECM tool comprising a tool body, the tool body comprising an electrode defining a working surface configured to oppose a workpiece during a pECM process; an electrolyte system configured to supply electrolyte to an interelectrode gap between the working surface of the electrode and a target surface of the workpiece; and a power supply configured to generate a pulsed direct current between the one or more electrodes of the pECM tool and the workpiece during the pECM process, wherein the electrode comprises: an oxidation resistant layer defining at least a portion of the working surface, and a diamond-like carbon coating that defines another surface of the electrode.

In some examples, the disclosure describes a pulsed electrochemical machining (pECM) tool comprising: a tool body defining a tool axis, the tool body comprising an electrode defining a working surface configured to face a workpiece, wherein the electrode comprises: an oxidation resistant layer defining at least a portion of the working surface, and a diamond-like carbon coating that defines another surface of the electrode.

In some examples, the disclosure describes a method for pulsed electrochemical machining (pECM) a workpiece, comprising: generating a pulsed direct current between an electrode of a machining tool and the workpiece, electrode defining a working surface configured to oppose a workpiece during a pECM process, wherein the electrode comprises: an oxidation resistant layer defining at least a portion of the working surface, and a diamond-like carbon coating that defines another surface of the electrode; delivering an electrolyte into an interelectrode gap between the working surface of the electrode and a target surface of the workpiece; and positioning the working surface of the one or more electrodes relative to the target surface of the workpiece to remove material from the target surface of the workpiece.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is a conceptual block diagram illustrating a pulsed electrochemical machining (pECM) system.

FIG. 1B is a side view cross-sectional conceptual diagram illustrating operation of a pECM tool of the pECM system of FIG. 1A.

FIG. 1C is a side view cross-sectional conceptual diagram illustrating a magnified view of a portion of FIG. 1B.

FIG. 1D is a conceptual block diagram illustrating an example control system of the pECM system of FIG. 1A.

FIGS. 2A and 2B are conceptual diagrams illustrating an example electrode and workpiece before and during a pECM process.

FIGS. 3-5 are conceptual diagrams illustrating other examples electrodes and workpieces for a pECM process.

FIG. 6 is a flow diagram illustrating an example technique for controlling the pECM system of FIG. 1A.

FIG. 7 is a timing diagram illustrating the delivery of pulsed DC current for an example pECM process including alternating polarity pulses.

### DETAILED DESCRIPTION

The disclosure generally describes systems and techniques related to pECM. As noted above, a pECM system may include a tool that imparts its shape into a workpiece in a mirror image. As the tool moves toward a surface of the workpiece to be machined, a pulsed DC current may be applied to the tool and the workpiece. The tool maintains a tiny interelectrode gap (e.g., of less than about 10 microns) from the surface of the workpiece, and the workpiece dissolves anodically about the tool, taking on the complementary shape of the tool. An electrolyte pumped between the tool and the workpiece may remove dissolved metal from the workpiece and heat.

The portion of the tool that defines the electrode may be formed of an electrically conductive material such as titanium or stainless steel. During the pECM process, this portion of the tool generally functions as the cathode and the workpiece functions as the anode (with electrodes flowing from the cathode to the anode) to dissolve a portion of the workpiece. During such a process, there may be an acidic zone adjacent to the workpiece in the electrolyte flowing in the interelectrode gap and, likewise, an alkaline zone adjacent to the tool in the electrolyte flowing in the interelectrode gap. The surface portions for the workpiece may dissolve in the acidic zone of the electrolyte flow.

However, depending on the composition of the workpiece and/or other variables, it may be difficult to dissolve a workpiece only using the tool as the cathode and the workpiece as the anode. For example, in the case of metal alloy workpieces, the metal alloy may include certain alloying elements (e.g., tungsten in some nickel alloys) that dissolve better in different pH environments compared to other elements of the alloy. In such examples, in may be desirable to switch the polarity of the tool and workpiece (e.g., periodically) during a pECM process, with the electrode portion of the tool defining the anode and the workpiece defining the cathode for a portion of the pECM process. In such instances, when the polarity switches, the acid and alkaline zones may reverse in the electrolyte flow. Without being bound by theory, the switch in acid and alkaline zones may assist in the removal of certain alloying elements (e.g., tungsten) from a metal alloy workpiece that would otherwise hinder the selective removal of the workpiece with the pECM process without the reversal in polarity.

While reversing the polarity of the tool and workpiece during portions of a pECM process may assist in the electrochemical machining of certain workpieces (e.g., certain metal alloy workpieces), such reversal may undesirably cause the dissolution of the conductive material of the tool electrode. For example, a stainless steel material defining the electrode portion of the tool may dissolve or otherwise wear away in an acidic environment caused by the reversal in polarity described above during a pECM process. Such wearing away may be particularly noticeable on sharp edges of the tool electrode. After multiple pECM processes employing period reversal in polarity, portions of the tool electrode may wear away causing, e.g., sharp edges and/or other precise features of the electrode to no longer by precisely defined. This may undesirably change the geometry of the features imparted into a workpiece by the tool during a pECM process.

In accordance aspects of the disclosure, in some examples, a pECM tool may include an oxidation resistant layer defining at least a portion of the electrode to prevent or otherwise reduce the wearing away of the electrode caused by the reversal of the polarity during a pECM process described above. For example, the tool may include an electrode formed of base member and an oxidation resistant layer on a least a portion of the base member to define at least a portion of the electrode working surface.

In some examples, the oxidation resistant layer may include at least one of a noble metal or a metal oxide. The particular composition of the oxidation resistant layer may be selected such that the layer is resistant to oxidation caused by the reversal in polarity during a pECM process. The particular composition of the oxidation resistant layer may be selected such that a current may be conducted across the layer to and from a workpiece opposing the tool electrode during the pECM process. Example materials for the oxidation resistant layer may include at least one of one or more noble metals (such as gold), or one or more metal oxides (such as iridium oxide or titanium oxide). The oxidation resistant layer may cover the entire surface (e.g., working surface) of the electrode or may be selectively applied to portions (e.g., at the edges of the electrode). In this manner, the geometry of the tool electrode may be preserved for pECM systems in which the tool electrode acts as an anode during a pECM process, and even after repeated iterations of such a pECM process.

The pECM tool may also include a second layer in addition to the oxidation resistant layer that is formed of a material different than that of the oxidation resistant layer. For example, the second layer may be formed of an electrically insulative material (such as a dielectric) that has a relatively low electrical conductivity (such as an electrical conductivity that is lower than the electrical conductivity of the oxidation resistant layer). In some examples, the second layer may be formed on lateral sides of the electrode with the oxidation resistant layer being formed on a “bottom” or “front facing” surface of the electrode. In this manner, the second layer may prevent electrical flow during a pECM process across surfaces of the electrode where it is undesired but instead directs the electrical flow across the oxidation resistant layer. This may allow for the selective removal of material from the workpiece only in areas of the workpiece interfacing with the portions of the electrode having the oxidation resistant layer and not in the portions covered by the second layer.

In some examples, the second layer is a diamond-like carbon (DLC) coating. DLC coatings may have improved wear resistance compared to tools with conventional tool coatings such as, for example, parylene, or adhesives such as epoxies, acrylics and urethanes. In some examples, the DLC coated electrode may provide the capability to generate more precisely machined metal parts. In addition, DLC coatings have excellent heat resistance, lubricity for resistance to galling, and anti-wear properties, all of which are beneficial for use as a dielectric coating for pECM.

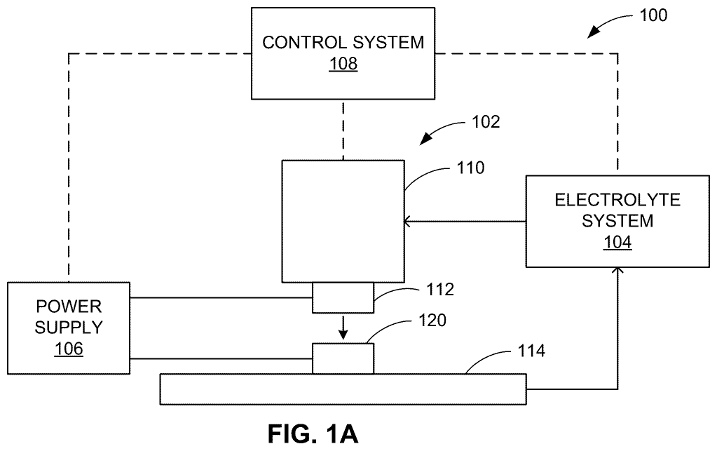

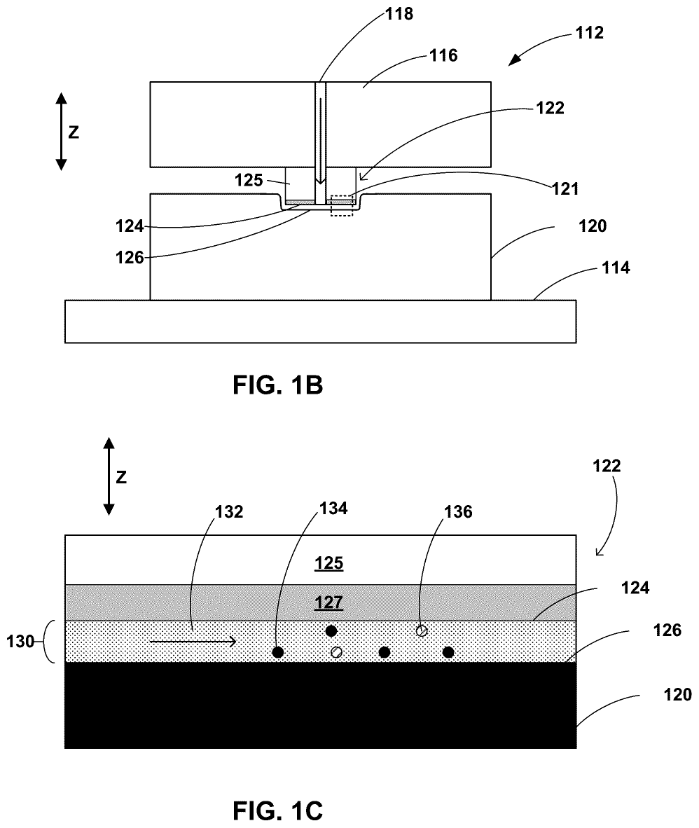

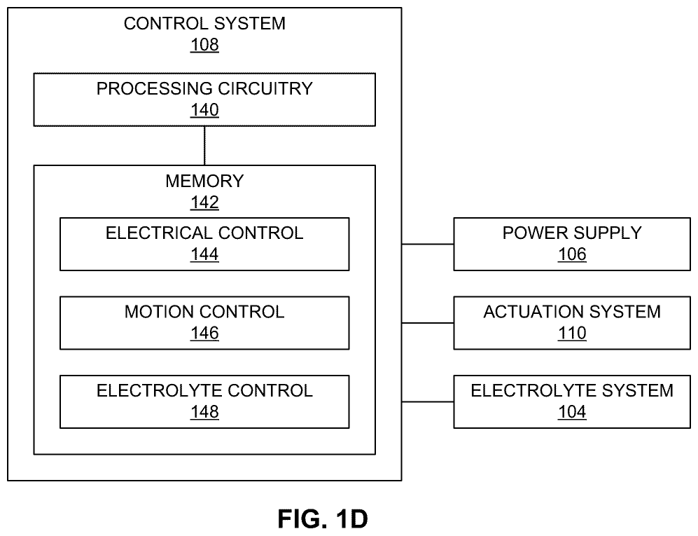

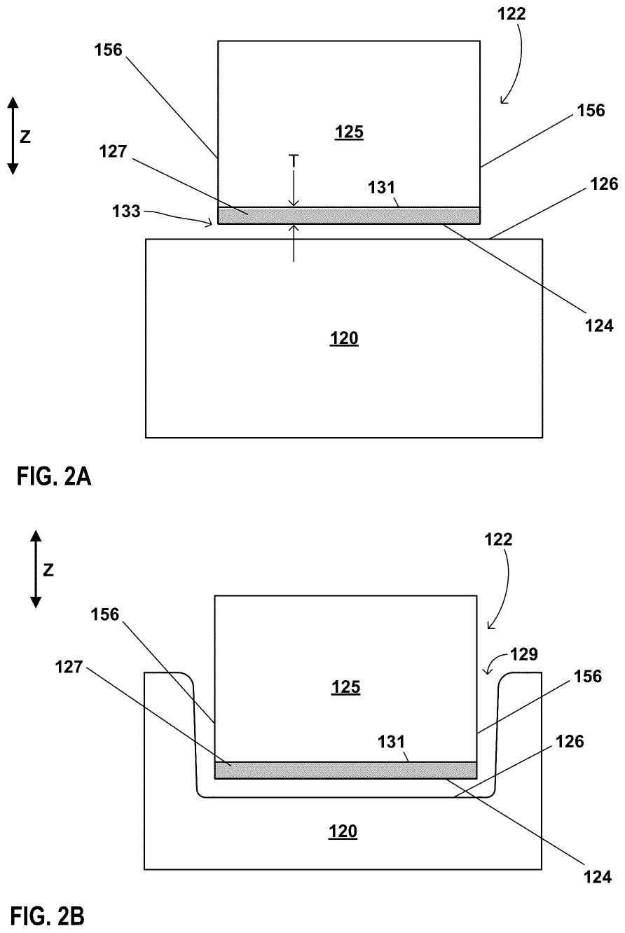

FIG. 1A is a schematic conceptual block diagram illustrating an example pulsed electrochemical machining (pECM) system 100 for machining a workpiece 120. pECM system 100 includes a mechanical system 102, an electrolyte system 104, a power supply 106, and a control system 108. While illustrated as separate components, the various components of pECM system 100 may be integrated with other components (e.g., power supply 106 incorporated into mechanical system 102) or overlap with other components (e.g., controllers of mechanical system 102 overlapping with control system 108). While examples of the disclosure are described primarily with regard to pulsed electrochemical machining processes performed by pECM system 100, other examples of the disclosure may be employed using other machining techniques that employ electrochemical machining to shape or otherwise selectively remove material from a workpiece.

Mechanical system 102 may include an actuation system 110, a machining tool 112, and an enclosure system 114. Actuation system 110 may be configured to control a position of machining tool 112 relative to workpiece 120. During a pECM process, actuation system 110 may adjust the position of tool 112 relative to workpiece 120 as needed by moving tool 112, workpiece 120, or both. Actuation system 110 may include one or more actuators, such as direct drive actuators, configured to move tool 112 and/or workpiece 120 as desired during a pECM process. For example, one or more actuators may be configured to feed or otherwise move machining tool 112 toward workpiece 120 during a pECM process. In some examples, actuation system 110 may be configured to oscillate machining tool 112 (e.g., up and down along the z-axis shown in FIGS. 1B and 1C). Such movement of tool 112 by actuation system may improve removal of dissolved material and restore a concentration of electrolyte between machining tool 112 and workpiece 120. As illustrated in the example of FIG. 1A, mechanical system 102 may be configured to receive electrolyte from electrolyte system 104 and discharge the electrolyte to or proximate to machining tool 112.

Machining tool 112 may be configured to mechanically couple to actuation system 110 and electrically couple to power supply 106. For example, machining tool 112 may include one or more structures or assemblies to couple to actuation system 110, such that machining tool 112 receives a control force for positioning machining tool 112, electrolyte (if distributed via mechanical system 102) for discharging from machining tool 112, and electrical current for generating an electric potential between machining tool 112 and workpiece 120. As will be described further in FIGS. 1B and 1C below, machining tool 112 may be configured to define a working surface that, in combination with workpiece 120 and the electrolyte supplied by electrolyte system 104, forms an electrolytic cell that dissolves material from the outer surface of workpiece 120 using electrolysis.

Enclosure system 114 may be configured to mount workpiece 120 and electrically couple workpiece 120 to power supply 106 for generating a voltage between machining tool 112 and workpiece 120 (e.g., in the form of a pulsed direct current). For example, enclosure system 114 may position workpiece 120 toward machining tool 112, such that a working surface of workpiece 120 is exposed to a working surface of machining tool 112. In some examples, enclosure system 114 may capture spent electrolyte from workpiece 120 for return to electrolyte system 104.

Electrolyte system 104 may be configured to condition and circulate electrolyte (e.g., liquid electrolyte) for distribution to a working surface of machining tool 112, such as via mechanical system 102. Electrolyte system 104 may include one or more pumps configured to discharge the electrolyte to mechanical system 102, one or more filters configured to filter contaminants from the electrolyte (e.g., for the re-use of electrolyte in the pECM process), one or more heat exchangers configured to remove heat from the electrolyte, and/or other components configured to maintain various parameters of the electrolyte.

Power supply 106 may be configured to generate an electric potential between machining tool 112 and workpiece 120. For example, power supply 106 may be configured to apply a voltage between machining tool 112 and workpiece 120 to generate current flow between machining tool 112 and workpiece 120 with the electrolyte flowing or otherwise present between machining tool 112 and workpiece 120. For a pulsed ECM process, power supply 106 may be configured to supply voltage in pulses, such as in combination with oscillations of machining tool 112 relative workpiece 120, to increase local current density. For example, power supply 106 may include a direct current (DC) source that applies a pulsed direct current to both machining tool 112 and workpiece 120 during the pulsed electrochemical machining process. In some examples, actuation system 110 may oscillate the position of machining tool 112 relative workpiece 120 in coordination with the pulsed direct current.

Control system 108 may be communicatively coupled to mechanical system 102, electrolyte system 104, and power supply 106, and configured to send control signals to mechanical system 102, electrolyte system 104, and power supply 106. For example, the control signals may cause mechanical system 102 to control (e.g., dynamically) a position of machining tool 112 relative to workpiece 120, cause electrolyte system 104 to supply electrolyte between machining tool 112 and workpiece 120, and cause power supply 106 to generate an electric potential between machining tool 112 and workpiece 120. Further operation of control system 108 will be described in FIG. 1D below.

Machining tool 112 defines a working surface that forms workpiece 120 into a component having a particular shape or set of dimensions (e.g., approximately the complimentary shape of machining tool 112). FIG. 1B is a side view cross-sectional conceptual diagram illustrating operation of machining tool 112 of pECM system 100 of FIG. 1A. Machining tool 112 includes a tool body 116 defining a tool axis that aligns with an axis of actuation system 110 of FIG. 1A. Tool body 116 includes one or more electrodes such as electrode 122. While illustrated in FIG. 1B as including a single electrode 122, tool body 116 may include multiple electrodes 122. Electrode 122 defines a working surface 124, which in the example of FIG. 1B is at a distal end of the tool axis. When machining tool 112 is attached to actuation system 110, each working surface 124 is configured to face a corresponding target surface 126 of workpiece 120. In some examples, such as illustrated in FIG. 1B, tool body 116 may include an electrolyte channel 118 configured to receive an electrolyte from electrolyte system 104 (e.g., via mechanical system 102) and discharge the electrolyte through one or more openings near working surface 124 of electrode 122.

Each electrode 122 includes an electrically conductive material at working surface 124. Likewise, workpiece 120 may be an electrically conductive material. When an electric potential (e.g., in the form of a pulse direct current) is generated between working surface 124 of electrode 122 and target surface 126 of workpiece 120 (e.g., with power supply under the control of control system 108), working surface 124 may form a cathode surface and target surface 126 may form an anode surface. As working surface 124 is advanced and material from workpiece 120 is removed, a shape of target surface 126 may generally correspond to the complimentary shape of working surface 124. While the shape of workpiece 120 is shown to mirror the shape of electrode 122 in FIG. 1B, in other examples, the dimensions and shape formed in workpiece 120 from the removal of material from workpiece 120 do not exactly mirror the shape of the tool 112.

FIG. 1C is a side view cross-sectional conceptual diagram showing a magnified view within window 121 indicated in FIG. 1B to illustrate operating principles of the pECM tool of FIG. 1B. Working surface 124 of electrode 122 is positioned relative to target surface 126 of workpiece 120 to form an interelectrode gap 130, and an electrolyte 132 flows through interelectrode gap 130. When an electric potential (e.g., in the form of a pulsed direct current) is generated between working surface 124 and target surface 126 with electrode 122 configured as the cathode and workpiece 120 configured as the anode, current flows from working surface 124 to target surface 126 via electrolyte 132 to form an electrolytic cell. The current dissolves material at target surface 126 to generate electrochemical reaction products that include dissolved material 134, hydrogen gas 136, and heat. Electrolyte 132 carries away the electrochemical reaction products from interelectrode gap 130. In general, material removal rate may be related to current density in interelectrode gap 130. The current density in interelectrode gap 130 may be related to a variety of parameters including, but not limited to: spatial parameters, such as a distance of interelectrode gap 130; electrical parameters, such as an electric potential across interelectrode gap 130; electrolyte parameters, such as a flow rate of electrolyte 132; and other parameters that may affect flow of current from working surface 124 to target surface 126.

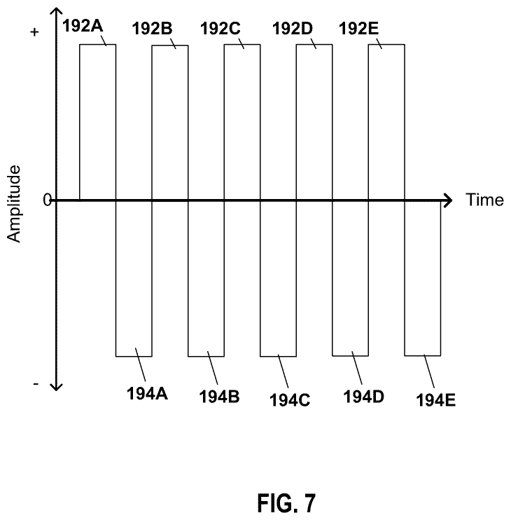

In accordance with some examples of the disclosure, the polarity of electrode 122 and workpiece 120 may be reversed at time during a pECM process carried out by system 100 with electrode 122 being the anode and the workpiece 120 being the cathode for some of the pulses delivered during the pECM process. In some examples, the polarity of electrode 122 and workpiece 120 may be alternated on a pulse by pulse basis as shown in the example timing diagram of FIG. 7. Other examples are contemplated for reversing polarity of electrode 122 and workpiece 120 beyond that of alternating on a pulse by pulse basis. As described above, in some examples, reversing (periodically) the polarity of electrode 122 and workpiece 120 assist in the electrochemical machining of certain workpieces (e.g., nickel superalloy and other metal alloy workpieces) as compared to a pECM process in which electrode 122 only acts as the cathode and workpiece 120 only acts as the anode.

The conductive materials of electrode 122 and workpiece 120 may be any suitable conductive material such as metal, metal alloy, and/or ceramic material. Examples of metals that may be used to form the workpiece 120 and the electrode 122 of tool 112 include nickel, iron, and titanium-based alloys in a variety of formats such as cast (including single crystal), forged, additively manufactured, and powdered metallurgy. Examples of suitable metals and metal alloys for the workpiece 120 and electrode 122 of tool 112 include, but are not limited to, any superalloy such as CMSX-4, MarM247, Haynes 230, Rene N-5, MP35N, and the like, steels such as 4140, A2 tool steel, M4 tool steel, and gear steels such as Ferrium C64, Al 6061, Al 7075, brass, bronze, CoCr, Cu, Ge, Inconels such as 625, 718, and 740h, Mo, Ni, Nitinol, Nitronic 60, Pyrowear 53, stainless steels such as 17-4, 304, 316, and 440C, Ti Grade 1-5, Ti 64, TiAl, and mixtures and combinations thereof.

Workpiece 120 may be a single crystal superalloy material. In some examples, workpiece 120 is a nickel superalloy such as CMSX-4 (also referred to as Cannon Muskegon Single Crystal 4^{th} mix)(available from Cannon Muskegon Corporation, Muskegon MI, USA) or other single crystal alloys. The nickel superalloy may have a composition including Chromium (e.g., about 5.5 weight (wt %) to about 7.5 wt %), Cobalt (e.g., about 9 wt % to about 11 wt %), Molybdenum (e.g., about 0.3 wt % to about 0.9 wt %), Tungsten (e.g., about 5 wt % to about 7 wt %), e.g., with the balance being nickel. In some examples, such a nickel superalloy may also include Titanium (e.g., about 0.5 wt % to about 1.5 wt %), Hafnium (e.g., about 0 wt % to about 0.2 wt %), Tantalum (e.g., about 5.5 wt % to about 6.5 wt %), Rhenium (e.g., about 2 wt % to about 4 wt %), and/or Rhenium (e.g., about 2 wt % to about 4 wt %) in trace amounts. In some examples, the workpiece 120 may be single crystal nickel-based superalloy comprising about 5.5 wt. % to about 7.5 wt. % chromium, about 8 wt % to about 11 wt % cobalt (such as about 9 wt % to about 11 wt % cobalt), and about 5 wt. % to about 7 wt % tungsten, e.g., further comprising at least one of about 0.3 wt % to about 0.9 wt % molybdenum, about 0.5 wt % to about 1.5 wt % titanium, about 5.5 wt % to about 7.5 wt % tantalum (such as about 5.5 wt % to about 6.5 wt % tantalum), about 5.0 wt % to about 6 wt. % aluminum, about 2 wt % to about 4 wt % rhenium, and/or up to about 0.5 wt % hafnium, e.g., with a remainder being nickel. A pECM process to machine such a superalloy workpiece 120 may beneficially include the periodic reversal of polarity of the delivered pulses with electrode 122 being the anode and workpiece 120 being the cathode.

While reversing the polarity of electrode 122 and workpiece 120 during portions of a pECM process may assist in the electrochemical machining of certain workpieces, such reversal may undesirably cause the dissolution of some types of conductive materials used for electrode 122. For example, in certain processing conditions, stainless steel and/or titanium electrodes may be susceptible to dissolution during a pECM process. Such dissolution may wear away portion of the work surface 124 of electrode 122, particularly after multiple different pECM processes.

In accordance with some examples of the disclosure, electrode 122 may include an oxidation resistance layer formed of a material that is resistant to oxidation, e.g., resulting from reversing the polarity of electrode 122 and workpiece 120 as described herein. As shown in FIG. 1B and in better detail in FIG. 1C (which is magnified view of window 121 in FIG. 1B), electrode 122 includes oxidation resistant layer 127 on base member 125. Oxidation resistant layer 127 is formed of an electrically conductive material to allow for current to be conducted to and from workpiece 120 during pECM process on workpiece 120. The electrically conductive material that forms oxidation resistant layer 127 is resistant to oxidation resulting from the reversal of polarity during a pECM process such that electrode 122 forms the anode and workpiece 120 forms the corresponding cathode. In some examples, oxidation resistant layer 127 comprises, consists of, or consists essentially of one or more noble metals. Noble metals include ruthenium (Ru), rhodium (Rh), palladium (Pd), osmium (Os), iridium (Jr), platinum (Pt), and gold (Au). Additionally, or alternatively, oxidation resistant layer 127 comprises, consists of, or consists essentially of a metal oxide. Example metal oxides for layer 127 may include iridium oxide (IrOx) and titanium oxide (TiOₓ). In some examples, the metal oxide may be an electrically conductive metal oxide that allows for suitable conduction of electrical signals across layer 127 to allow for the system to function for the pECM processes described herein. Base member 125 may be formed of an electrically conductive material, e.g., that is less resistant to oxidation from the reversal of polarity during a pECM process than that of oxidation resistant layer 127. In some examples, base member 125 comprises, consists of, or consists essentially of one or more of titanium, steel (such as stainless steel) copper, brass and/or metals/materials that will accept the oxide resistant layer described herein.

FIG. 1D is a conceptual block diagram illustrating an example control system 108 of pECM system 100 of FIG. 1A. Control system 108 includes processing circuitry 140 and a memory 142. Memory 142 includes computer-readable instructions that, when executed by processing circuitry 140, causes processing circuitry 140 to perform various functions related to control of components of pECM system 100. Processing circuitry 140 may include any one or more microprocessors, controllers, digital signal processors (DSPs), application specific integrated circuits (ASICs), field-programmable gate arrays (FPGAs), or equivalent discrete or integrated digital or analog logic circuitry, and the functions attributed to processing circuitry 140 herein may be embodied as software, firmware, hardware or any combination thereof. Memory 142 may include any volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital media.

Memory 142 may store any suitable information, including information for executing one or more electrochemical machining processes with which pECM system 100 performs on workpiece 120. For example, memory 142 may store one or more of electrical control instructions 144, motion control instructions 146, and electrolyte control instruction 148 in separate memories within memory 142 or separate areas within memory 142. Electrical control 144, motion control 146, and electrolyte control 148 may, in combination, define parameters that control pECM system 100 to remove material from workpiece 120 to generate a component having particular dimensions. In some examples, workpiece 120 may be a partially fabricated component having relatively rough dimensions, such that the pECM process may further refine workpiece 120 to relatively fine dimensions.

Electrical control 144 may define values for electrical parameters of a pECM process including, but not limited to, voltage amplitude applied to electrode 122 and workpiece 120, frequency of electric current, duty cycle (e.g., pulse length), current amplitude, and other electric parameters associated with control of current across interelectrode gap 130. Processing circuitry 140 may generate and send control signals that include the electrical parameters to electrical control circuitry of power supply 106. Electrical control 144 may define the polarity of workpiece 120 and electrode 122 of tool 112 for the pulsed direct current applied between electrode 122 and workpiece 120 during a pECM process. As described herein, in some examples, electrode 122 may function as a cathode and workpiece 120 may function as an anode during a pECM process. Optionally, electrical control 144 may reverse the polarity of electrode 122 and workpiece 120, e.g., on a periodic basis, to assist in removal of portions of workpiece 120 during a pECM process, e.g., in cases in which workpiece 120 is a metal alloy including certain alloying elements.

Motion control 146 may define values for motion parameters of a pECM process including, but not limited to, feed rate of machining tool 112, position of machining tool 112 (e.g., depth limit of machining tool 112), frequency of oscillation of machining tool 112, amplitude of oscillation of machining tool 112, length of interelectrode gap 130, and other motion parameters associated with control of relative and/or time-varying position of working surface 124. Processing circuitry 140 may generate and send control signals that include the motion parameters to actuation circuitry of actuation system 110.

Electrolyte control 148 may define values for electrolyte parameters of a pECM process including, but not limited to, flow rate of electrolyte 132 through interelectrode gap 130, temperature of electrolyte 132, and other electrolyte parameters associated with conditions of electrolyte 132 in interelectrode gap 130. Processing circuitry 140 may generate and send control signals that include the electrolyte parameters to electrolyte control circuitry of electrolyte system 104.

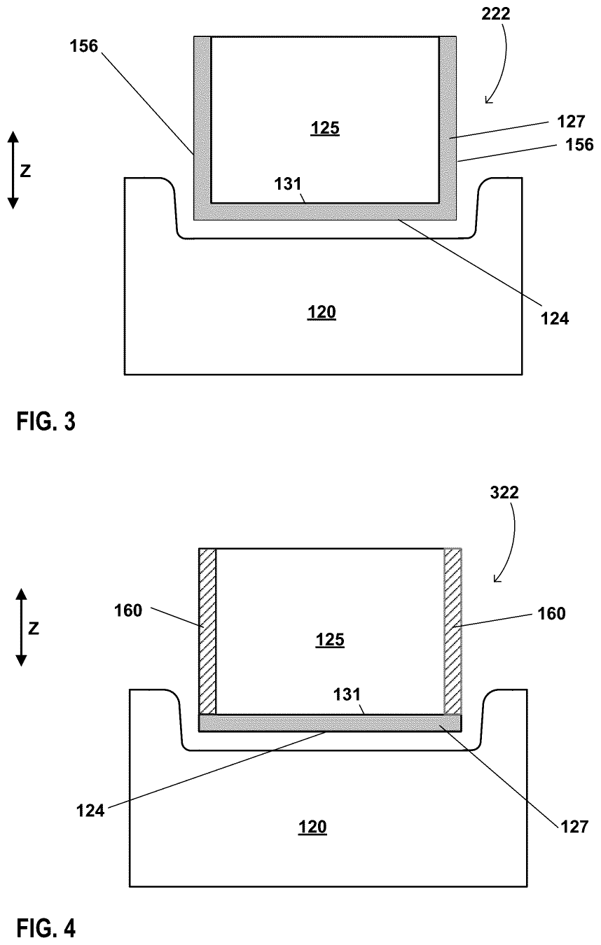

FIGS. 2A and 2B are conceptual diagrams illustrating electrode 122 and workpiece 120 of system 100 before and during, respectively, a pECM process to selectively remove a portion of workpiece 120. For ease of illustration, the other portions of pECM system 100 in FIGS. 1A and 1B are not shown in FIGS. 2A and 2B.

As shown in FIG. 2A, prior to the removal of a portion of workpiece 120, target surface 126 may be substantially flat (planar) without any channels or other grooves formed into target surface 126. At least a portion of working surface 124 of electrode 122 opposes target surface 126 of workpiece 120 with surface 124 directly facing target surface 126. Lateral sides 156 of electrode 122 extend from away from the portion of working surface 124 facing at a non-zero angle (approximately 90 degrees in the examples of FIGS. 2A and 2B).

In the depiction of FIG. 2B, electrode 122 has been advanced along the Z-axis labelled in FIGS. 2A and 2B towards target surface 126 during the pECM process (e.g., in a oscillating manner) and has removed a portion of workpiece 120 to form a recessed channel 129 into the surface plane of workpiece 120. In such a configuration, a portion of lateral sides 156 of electrode 122 also oppose the recessed surface of workpiece 120 and may define a portion of working surface 124 along with the “bottom” surface of electrode 122.

As shown in FIGS. 2A and 2B, rather than being formed of a single unitary piece of conductive material, electrode 122 includes oxidation resistant layer 127 on a portion of base member 125. Oxidation resistant layer 127 forms at least a portion of working surface 124 of electrode 122 during the pECM process. Both base member 125 and oxidation resistant layer 127 may be formed of electrically conductive materials that allow for a current to be conducted between electrode 122 and workpiece 120 during the pECM process, e.g., in the formed of direct current pulses. However, oxidation resistant layer 127 may be formed of a first material that is different (e.g., has a different composition and/or other properties) than a second material that forms base member 125 of electrode 122. For example, the first material of oxidation resistant layer 127 may be more resistant to oxidation resulting from the operation of electrode 122 as an anode rather than cathode during a pECM process, e.g., in instances in which the polarity of electrode 122 and workpiece 120 are periodically reversed, as compared to the second material of base member 125.

Any suitable electrically conductive materials may be employed for base member 125 and oxidation resistant layer 127. As described above, in some examples, oxidation resistant layer 127 comprises, consists of, or consists essentially of one or more noble metals. Noble metals include ruthenium (Ru), rhodium (Rh), palladium (Pd), osmium (Os), iridium (Jr), platinum (Pt), and gold (Au). Additionally, or alternatively, oxidation resistant layer 127 comprises, consists of, or consists essentially of a metal oxide. Example metal oxides for layer 127 may include iridium oxide (IrOx) and titanium oxide (TiOₓ). In some examples, the metal oxide may be an electrically conductive metal oxide that allows for suitable conduction of electrical signals across layer 127 to allow for the system to function for the pECM processes described herein. Base member 125 may be formed of an electrically conductive material, e.g., that is less resistant to oxidation from the reversal of polarity during a pECM process than that of oxidation resistant layer 127. In some examples, base member 125 comprises, consists of, or consists essentially of one or more of titanium, steel (such as stainless steel) copper, brass and/or metals/materials that will accept the oxide resistant layer described herein.

Oxidation resistant layer 127 may be formed on all or a portion of surface 131 of base member 125 to define at least a portion of the surface of electrode 122 that functions as a working surface during the pECM process (e.g., the surface across which a current is conducted with target surface 126 of workpiece 120 to oxidize a portion of workpiece 120 for selective pulsed electrochemical machining as described herein). As used herein, “formed on” and “on” means that layer 127 may be “formed directly on” and “directly on” surface 131 such that there are no intermediate layers or coatings or may denote that one or more intermediate layers is present between layer 127 and surface 131. In some examples, as shown in FIG. 1, oxidation resistant layer 127 may be directly on surface 131 of base member 125. In other examples, one or more layers of a material may be between surface 131 and layer 127, e.g., that function as a bond layer that increases adherence of layer 127 to surface 131.

In the example of FIGS. 2A and 2B, oxidation resistant layer 127 forms one or more edges such as edge 133 (also referred to as corners) of electrode 122 defined by the intersection between the “bottom” surface of electrode 122 directly facing working surface 126 of workpiece 120 and lateral walls 156 of electrode 122. Such edges may be particularly susceptible to oxidation caused by the reversal of polarity during a pECM process as described herein (e.g., with electrode 122 defining an anode and workpiece 120 defining a cathode) without the inclusion of oxidation resistant layer 127, e.g., with base member 125 defining the edge of the electrode 122 rather than layer 127. In this manner, layer 127 may help maintain a well-defined edge 133 of electrode 122 even over multiple uses of electrode 122 to pECM different workpieces.

Oxidation resistance layer 127 may have any suitable thickness T. In some examples, thickness T of layer 127 may be substantially constant across surface 131 of base member 125 while in other examples the thickness T may vary across surface 131. The thickness T of layer 127 may be enough to prevent or otherwise protect surface 131 of base member 125 from oxidation caused by instances of reverse polarity during a pECM process as described herein. In some examples, thickness T may be at least about 5 microns, such as about 5 microns to about 150 microns, about 50 microns to about 500 microns, or about 50 microns to about 150 microns, and/or less than about 500 microns or less than about 150 microns. Other thicknesses are contemplated.

Oxidation resistant layer 127 may be deposited or otherwise formed on base member 125 using any suitable technique. The particular technique employed to form layer 127 may depend on the composition of layer 127 and/or the desired area of base member 125 desired to be overlayed with layer 127. In some examples, oxidation resistant layer 127 may be formed using an electroplating technique, e.g., in the case of layer 127 including or otherwise being formed of gold. Suitable self-aligning molecule (SAM) plating processes may be employed to form layer 127, e.g., in the case of layer 127 including or otherwise being formed of gold. Other techniques may include vapor deposition processes, gilding (by applying a thin layer of material and then tacking or otherwise attaching the layer of material to base member 125), a spray (thermal spray) process (e.g., in combination with machining), and the like. In some example, a passivation layer, e.g., in the form of an oxide layer for layer 127, can be applied as a natural passivation layer (e.g., by purposefully oxidizing a metallic layer or other material on the surface of base member 125 or as which forms base member 125. A passivation layer may be “enhanced” by processing techniques to achieve desired properties for the layer, e.g., to improve the oxidation resistance of the layer. It could be a natural passivation layer or an “enhanced” passivation layer via processing means to achieve the desired layer properties The thickness of layer 127 may depend on the technique employed to form the layer 127. In some examples, oxidation resistant layer 127 may be formed to have a relatively low porosity, or may have substantially no porosity, in order to prevent wear/erosion of the base material and/or the protective layer.

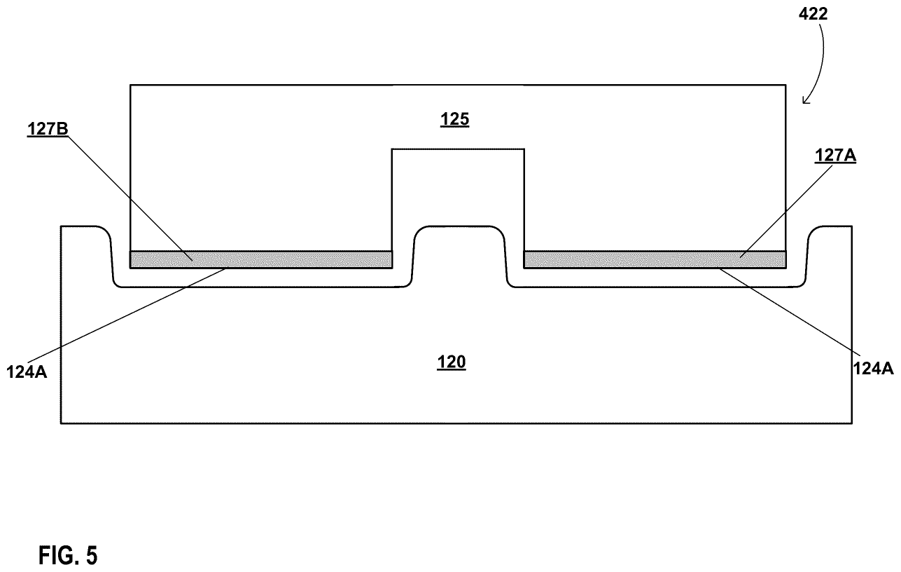

FIG. 3 is a conceptual diagram illustrating another example electrode 222 during a pECM process to remove a portion of workpiece 120. Electrode 222 is an alternative to electrode 122 in FIGS. 2A and 2B. Electrode 222 may be substantially the same as described for electrode 122 and may be employed in tool 112 of system 100 for a pECM process. Like electrode 122, electrode 222 includes oxidation resistant layer 127 formed on at least a portion of base member 125. However, unlike electrode 122, oxidation resistant layer 127 is present on base member 125 such that defines the outer surfaces of both the “bottom” surface (e.g., the surface directly facing target surface of workpiece 120, the surface orthogonal to Z-axis of tool 112, or the surface of electrode 222 most distal relative to the Z-axis) and lateral sides 156 of electrode 122. In some examples, the “bottom” surface may be referred to as the “front face” of electrode 222. Such outer surfaces define at least a portion of working surface 124 of electrode 222. In this manner, layer 127 protects both the “bottom” and lateral sides 156 of electrode 222 from oxidation, e.g., by covering substantially all of the outer surface of base member 125. Like electrode 122, layer 127 defines the edges of electrode 222 formed at the transition from the “bottom” surface and the lateral sides 156.

FIG. 4 is a conceptual diagram illustrating another example electrode 322 during a pECM process to remove a portion of workpiece 120. Electrode 322 is an alternative to electrode 122 in FIGS. 2A and 2B and electrode 222 in FIG. 3. Electrode 322 may be substantially the same as described for electrode 122 and may be employed in tool 112 of system 100 for a pECM process. Like electrode 122, electrode 322 includes oxidation resistant layer 127 formed on at least a portion of base member 125.

However, unlike electrode 122, electrode 322 includes second layer 160 formed on base member 125 in addition to oxidation resistant layer 127. In the example of FIG. 4, oxidation resistant layer 127 is present on base member 125 such that defines the outer surface the “bottom” surface (e.g., the surface directly facing target surface of workpiece 120, the surface orthogonal to Z-axis of tool 112, or the surface of electrode 222 most distal relative to the Z-axis). Conversely, second layer 160 is present on base member 125 lateral sides 156 of electrode 122.

Second layer 160 is formed of a different material than oxidation resistant layer 127. In some examples, second layer 160 includes or is otherwise formed of a dielectric material, e.g., so that second layer 160 is a dielectric coating. In some examples, second layer 160 includes or is otherwise formed of an electrically insulative material (such as a dielectric) that has a relatively low electrical conductivity (such as an electrical conductivity that is lower than the electrical conductivity of oxidation resistant layer 127). In this manner, second layer 160 may prevent electrical flow during a pECM process across surfaces of electrode 122 where it is undesired but instead directs the electrical flow across oxidation resistant layer 127. This may allow for the selective removal of material from workpiece 120 only in areas of workpiece 120 interfacing with the portions of electrode 122 having oxidation resistant layer 127. Example materials for second layer 160 include epoxy-based, enamel-based, and/or ceramic-based coatings (e.g., with low electrical conductivity).

In some examples, second layer 160 may include or consist of a diamond-like carbon (DLC) material in the form of a DLC coating. In some examples, the DLC coating may increase dimensional accuracy, e.g., when pECM-machining metal alloy workpieces. DLC coatings have a number of beneficial properties that can reduce or eliminate electron flow through the coating. In addition, DLC coatings may have improved wear resistance compared to tools with conventional tool coatings such as, for example, parylene, or adhesives such as epoxies, acrylics and urethanes. In some examples, the DLC coated electrode may provide the capability to generate more precisely machined metal parts. In addition, DLC coatings have excellent heat resistance, lubricity for resistance to galling, and anti-wear properties, all of which are beneficial for use as a dielectric coating for pECM.

The diamond-like carbon (DLC) for second layer 160 may include one or more allotropes of carbon, diamond (sp³) and graphite (sp²). Diamond (sp³) has carbon atoms arranged in 3 dimensional cubic lattices while graphite (sp²) has a layered, planar structure in which the layers are arranged in a honeycomb lattice. In some examples, the DLC in second layer 160 is tetrahedral amorphous carbon (ta-C), which consists of sp³ bonded carbon atoms. In some examples, the DLC in the second layer 160 includes mixtures of sp² and sp³ carbon phases, and is amorphous, which in this application means that the DLC has no dominant crystalline lattice structure. In some cases, the DLC in the second layer 160 is formed with random alternations between cubic and hexagonal lattices, which creates no long-range order and therefore no fracture planes along which to break. The result is an exceptionally hard material for the second layer 160.

In some examples, the second layer 160 is a thin film consisting of DLC. In some examples, the thin film of DLC can include an additional pre-coat such, as for example, a plasma nitride. In some examples, the DLC can optionally include additional elements to modify its properties. For example, in some cases the DLC forming second layer 160 may include mixtures of sp² and sp³ carbon along with dopants such as Si, F, SiOₓ, TiOₓ, W, WC, Cr, CrN, H, and mixtures and combinations thereof. The control of the properties of the DLC in the second layer 160 can depend on various factors such as, for example, flux characteristics of the chosen deposition technique used to apply the coating (for example, physical vapor deposition (PVD), sputtering, or Pa-CVD), metal and hydrogen content, sp²:sp³ ratio, dopant, substrate bias voltage, ion energy and ion density as well as substrate temperature. Thus, many attributes of second layer 160, such as coating thickness, uniformity, hardness, resistivity, hydrogen content, and the like can be controlled as needed for various applications.

For example, DLC film hardness and sp³ content can be tailored for specific applications. For example, metal and hydrogen containing DLC (Me-DLC or a-C:H:Me) exhibit hardness in the range of about 500-2000 HV with 35% sp³, metal free DLC (C-DLC or a-C:H) typically has a hardness of about 1000-4000 HV and up to 75% sp³, while tetrahedral amorphous carbon (ta-C) can have a hardness of about 4000-9000 HV with 80-85% sp³.

In some examples, which are not intended to be limiting, the second layer 160 includes a DLC coating applied to base member 125 by a process such as physical vapor deposition (PVD), plasma assisted physical vapor deposition (PACVD), plasma enhanced physical vapor deposition (PECVD), sputtering, and the like. A non-line of sight application coating process such as PCD can coat internal surfaces of the tool 114, complicated tool geometry, and the like. The thinness of the DLC coating as applied with these processes has a negligible impact on the machining process, and can ensure better dimensional accuracy in the machined part. In some examples, the “bottom” of base member 125 and walls 156 may be coated with second layer 160 using a suitable technique. In such an example, portions of second layer 160 may be selectively removed, e.g., from the “bottom” of base member 125. Those portions may then be at least partially covered with oxidation resistant layer 127, e.g., to form the architecture shown in FIG. 4. Any suitable removal techniques may be employed including, e.g., machining processes.

In some examples, suitable materials for second layer 160 include those available from IBC Coatings Technologies, Lebanon, IN, under the trade designation CeraTough, particularly CeraTough 701 and 702, which are Si-doped DLCs. The Si-doped DLCs have a chemical composition of a-C:H:Si and include a mixture of sp² and sp³ carbon. In some examples, the Si doped DLC can include additional dopants such as, for example, Cr, W, and combinations thereof.

In some examples, second layer 160 has a thickness sufficient to block electron flow through the surface base member 125 to which the coating is applied. In some examples, second layer 160 has a thickness of about 1 micron to about 50 microns, or about 1 micron to about 25 microns, or about 1 micron to about 10 microns, or about 1 micron to about 5 microns.

In some examples, second layer 160 may include one or more of the example coatings and materials described in U.S. patent application Ser. No. 17/645,689, filed Dec. 22, 2021, the entire content of which is incorporated by reference herein.

DLC coating may be employed for a variety of reasons other than forming second layer 160. In some examples, a DLC coating may be used to prevent oxidation to a normally oxidizing material used in the pECM environment, such as a locator feature, (a hardened steel tooling ball that is not a stainless steel material) or on screws or nuts formed of a material without the desired oxide resistance or the strength or hardness needed).

As another examples, DLC coatings may be used on a component in the assembly that may gall if both mating components were the same material and hardness, (a stainless steel screw inserted into a threaded hole in a stainless structural member that will be assembled and disassembled often). These examples do not use the DLC coating to prevent electrical flow as described in part for second layer 160, but to prevent oxidation, and or improve lubricity or hardness of the surface of the component. We have several instances where the DLC coating was used for these purposes in fixtures and pECM related assemblies. As such, second layer 160 may also function to prevent oxidation, and or improve lubricity or hardness of the surface of electrode 322.

FIG. 5 is a conceptual diagram illustrating another example electrode 422 during a pECM process to remove a portion of workpiece 120. Electrode 422 is an alternative to electrode 122 in FIGS. 2A and 2B, electrode 222 in FIG. 3, and electrode 322 in FIG. 4. Electrode 422 may be substantially the same as described for electrode 122 and may be employed in tool 112 of system 100 for a pECM process. Like electrode 122, electrode 422 includes oxidation resistant layer 127 formed on at least a portion of base member 125.

However, unlike electrode 122, the oxidation resistant layer on electrode 422 includes two separate portions (first portion 127A and second portion 127B) on two different portions of base member 125. Instead of the entire outer surface of base member 125 being covered with the oxidation layer, only the two leading portions of electrode 422 (or most distal or “bottom” portions of electrode 422) are covered with oxidation resistant layers 127A and 127B. In this manner, the “edges” of base member 125 are protected from erosion during operation in a reverse polarity mode with electrode 422 defining the anode during a pECM process. While the lateral walls of base member 125 are shown as being uncovered, in other examples, a layer of material such as that described for second layer 160 may be applied to the lateral walls.

In some examples, oxidation resistant layer 127 (covering one or multiples surface portions) may be only applied to the face(s) of an electrode where electrical energy needs to flow during a pECM process, e.g., to selectively remove portions of workpiece 120. For example, if the oxide resistant layer 127 was on other areas of the electrode, the layer 127 would provide a path for electrical flow which would typically be undesirable for dimensional accuracy and detail sharpness of the resultant workpiece being selectively machined via the pECM process. As described herein (e.g., with regard to FIG. 4), in some examples, an electrically insulative layer (e.g., a DLC layer or other insulating layer) may be formed on the other surfaces of the electrode to provide for a surface with a relatively low electrical conductivity in areas other those covered by oxidation resistant layer 127. This may direct electrical flow through layer 127 rather than the areas of the electrode with the electrically insulating material. Such a configuration may provide for selective removal of workpiece 120 only in areas interfacing with layer 127 during a pECM process such as that described herein.

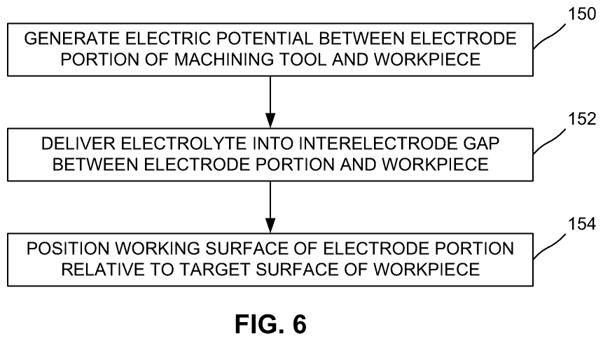

FIG. 6 is a flow diagram illustrating an example technique for controlling pECM system 100 of FIG. 1A. While illustrated sequentially, the various steps of FIG. 1E may be initiated in a different order (or sequentially) to remove material from workpiece 120. Control system 108 may cause power supply 106 to generate an electric potential between electrode 122 and workpiece 120 (150) and cause electrolyte system 104 to deliver electrolyte 132 into interelectrode gap 130 between working surface 124 of electrode 122 and target surface 126 of workpiece 120 (152) to form an electrolytic cell. The electrical potential may be controlled such that a plurality of electrical pulses are delivered between electrode 122 and workpiece 120 during the pECM process. The pulses may be delivered with an interval of time between each pulse, e.g., where the amplitude may be approximately zero or at some non-zero baseline amplitude value.

During the pECM process, control system 108 may cause actuation system 110 to position working surface 124 of electrode 122 relative to target surface 126 of workpiece 120 (154) to control the size of interelectrode gap 130 and advance working surface 124 toward target surface 126 as material is removed from workpiece 120. In some examples, interelectrode gap 130 may be on the order of about 10 microns although other values are contemplated. The positioning of working surface 124 relative to target surface 126 of workpiece 120 (150) may include moving electrode 122 relative workpiece 120 in an oscillating fashion during the pECM process, e.g., by moving electrode 122 in an “up” and “down” manner on a repeated basis. The oscillations may be coordinated with the delivery of the plurality of pulses described above.

In some examples, electrode 122 may primarily (e.g., solely) function as a cathode during a pECM process with workpiece 120 functioning as the anode. During the pECM process, workpiece 122 may dissolves anodically about the tool, taking on the complementary shape of electrode 122. The electrolyte pumped between the tool and the workpiece may remove dissolved metal from the workpiece and heat. The electrolyte flow helps to flush out hydrogen gas that is created in the gap from the pECM process. There is some heat generated in the gap, as this is a chemical transition by-product, but the heat content is not high. This may be one of the benefits of pECM in general, the heat isn't high enough to create hydrogen embrittlement of the base workpiece material and there is virtually no heat affected zone, unlike EDM. During such a process, there may be an acidic zone adjacent to the workpiece 120 in the electrolyte flowing in the interelectrode gap and, likewise, an alkaline zone adjacent to electrode 122 in the electrolyte flowing in the interelectrode gap. The surface portions for the workpiece 120 may dissolve in the acidic zone of the electrolyte flow.

However, depending on the composition of the workpiece and/or other variables, it may be difficult to dissolve a workpiece only using electrode 122 only as the cathode and the workpiece 120 only as the anode. For example, in the case of metal alloy workpieces, the metal alloy may include certain alloying elements (e.g., tungsten in some nickel alloys) that dissolve better in different pH environments compared to other elements of the alloy. In such examples, in may be desirable to switch the polarity of the tool and workpiece (e.g., periodically) during a pECM process, with the electrode portion of the tool defining the anode and the workpiece defining the cathode for a portion of the pECM process. In such instances, when the polarity switches, the acid and alkaline zones may reverse in the electrolyte flow. Without being bound by theory, the switch in acid and alkaline zones may assist in the removal of certain alloying elements (e.g., tungsten) from a metal alloy workpiece that would otherwise hinder the selective removal of the workpiece with the pECM process without the reversal in polarity.

In accordance with some examples of the disclosure, the polarity of electrode 122 and workpiece 120 may be reversed at time during a pECM process carried out by system 100 with electrode 122 being the anode and the workpiece 120 being the cathode for some of the pulses delivered during the pECM process. In some examples, the polarity of electrode 122 and workpiece 120 may be alternated on a pulse by pulse basis as shown in the example timing diagram of FIG. 7. Other examples are contemplated for reversing polarity of electrode 122 and workpiece 120 beyond that of alternating on a pulse by pulse basis. As described above, in some examples, reversing (periodically) the polarity of electrode 122 and workpiece 120 assist in the electrochemical machining of certain workpieces (e.g., nickel superalloy and other metal alloy workpieces) as compared to a pECM process in which electrode 122 only acts as the cathode and workpiece 120 only acts as the anode.

FIG. 7 is a timing diagram illustrating the delivery of a pulsed DC current over a period of time in a pECM process with the periodic delivery of reverse polarity pulses. For example, pulses 192A-192E are individual pulses conducted between electrode 122 and workpiece 120 having a positive amplitude (e.g., with electrode 122 functioning as the cathode) and pulses 194A-194E are individual pulses conducted between electrode 122 and workpiece 120 having an opposite (negative) amplitude (e.g., with electrode 122 functioning as the anode). While the pulses are shown to alternate polarity on a one to one pulse basis, other examples may include alternating on a two to one pulse basis (e.g., one reversed polarity pulse delivered after two pulses with electrode 122 functioning as the cathode).

In the example of FIG. 7, there is substantially no time between adjacent pulses while in other examples, there may be a period of time between respective pulses when the amplitude is zero or some baseline (or task) amplitude.

Pulses 192A-192F and pulses 194A-194F may have any suitable amplitude. In some examples, pulses 192A-192F may have the same amplitude and pulse width as pulses 194A-194F, while in others the amplitude and/or pulse width may be different. In some examples, pulses 192A-192F and/or pulses 194A-194F may have an amplitude of about 1 volt to about 5 volts and pulse width of about 1 millisecond to about 5 milliseconds. In some examples, negative pulses 194A-194F may be longer in duration than pulses 192-A-192F, e.g., when some elements in the workpiece 120 material need to be exposed for a longer period of time, especially when the “negative” voltage lower than the standard pulse voltage.

Pulses 192A-192F and pulses 194A-194F may be delivered collectively at any suitable frequency. In some examples, the pulses are delivered at a frequency of about 20 to about 100 hertz (Hz).

While the pulse shown in FIG. 7 are rectangular pulses, other pulse waveforms may be employed, e.g., with pulses 192A-192F and pulses 194A-194F being defined by a sinusoidal waveform or the like. In some examples, there may be a dwell or rest time in each cycle between the transition from positive to negative that is not shown in FIG. 7. Also, the positive duration and intensity as compared to the negative may not be equal.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following clauses and claims.

Clause 1A. A pulsed electrochemical machining (pECM) system, comprising: an pECM tool comprising a tool body, the tool body comprising an electrode defining a working surface configured to oppose a workpiece during a pECM process; an electrolyte system configured to supply electrolyte to an interelectrode gap between the working surface of the electrode and a target surface of the workpiece; and a power supply configured to generate a pulsed direct current between the one or more electrodes of the pECM tool and the workpiece during the pECM process, wherein the electrode comprises an oxidation resistant layer defining at least a portion of the working surface, the oxidation resistant layer comprising at least one of a noble metal or a metal oxide.

Clause 2A. The system of clause 1A, wherein the electrode includes a base member including a conductive material, wherein the oxidation resistant layer overlays at least a portion of the base member, and wherein the oxidation resistant layer is configured to reduce oxidation of conductive material of the base member while the electrode functions as an anode during the pECM process.

Clause 3A. The system of clause 2A, wherein the conductive material of the base member includes titanium.

Clause 4A. The system of any one of clauses 1A-3A, wherein the power supply is configured to generate the pulsed direct current between the electrode of the pECM tool and the workpiece during the pECM process with the electrode being an anode during a first portion of the process and being a cathode during a second portion of the pECM process.

Clause 5A. The system of clause 4A, wherein the electrode is configured to alternate between being the anode and being the cathode during the pECM process on a one to one basis.

Clause 6A. The system of any one of clauses 1A-5A, wherein the oxidation resistant layer comprises the noble metal.

Clause 7A. The system of clause 6A, wherein the noble metal comprises at least one of gold or platinum.

Clause 8A. The system of any one of clauses 1A-5A, wherein the oxidation resistant layer comprises the metal oxide.

Clause 9A. The system of clause 8A, wherein the metal oxide includes iridium oxide.

Clause 10A. The system of any one of clauses 1A-9A, wherein the oxidation resistant layer defines an edge of the electrode.

Clause 11A. The system of any one of clauses 1A-10A, wherein oxidation resistant layer defines only a first portion of the working surface.

Clause 12.A The system of clause 11A, wherein the electrode includes a diamond-like carbon coating that defines a second portion of the working surface of the electrode.

Clause 13A. The system of clause 12A, wherein the first portion of the working surface defines a face of the electrode and the second portion defines sides of the electrodes adjacent to the face.

Clause 14A. The system of any one of clauses 1A-13A, wherein the oxide resistant layer has a thickness of about 5 microns to about 150 microns.

Clause 15A. The system of any one of clauses 1A-14A, further comprising a mechanical system configured to oscillate a position the working surface of the electrode relative to the workpiece during the pECM process.

Clause 16A. A pulsed electrochemical machining (pECM) tool, comprising: a tool body defining a tool axis, the tool body comprising an electrode defining a working surface configured to face a workpiece, wherein the electrode comprises an oxidation resistant layer defining at least a portion of the working surface, the oxidation resistant layer comprising at least one of a noble metal or a metal oxide.

Clause 17A. The pCEM tool of clause 16A, wherein the tool is in accordance with the tool of one or more of clauses 1A-15A.

Clause 18A. A method for pulsed electrochemical machining (pECM) a workpiece, comprising: generating a pulsed direct current between an electrode of a machining tool and the workpiece, electrode defining a working surface configured to oppose a workpiece during a pECM process, wherein the electrode comprises an oxidation resistant layer defining at least a portion of the working surface, the oxidation resistant layer comprising at least one of a noble metal or a metal oxide; delivering an electrolyte into an interelectrode gap between the working surface of the electrode and a target surface of the workpiece; and positioning the working surface of the one or more electrodes relative to the target surface of the workpiece to remove material from the target surface of the workpiece.

Clause 19A. The method of clause 18A, wherein the method if performed using the system of any one of clauses 1A-15A.

Clause 1B. A pulsed electrochemical machining (pECM) system, comprising: an pECM tool comprising a tool body, the tool body comprising an electrode defining a working surface configured to oppose a workpiece during a pECM process; an electrolyte system configured to supply electrolyte to an interelectrode gap between the working surface of the electrode and a target surface of the workpiece; and a power supply configured to generate a pulsed direct current between the one or more electrodes of the pECM tool and the workpiece during the pECM process, wherein the electrode comprises an oxidation resistant layer defining at least a portion of the working surface, the oxidation resistant layer comprising at least one of titanium oxide, iridium oxide, platinum, or gold, and wherein the workpiece comprises a single crystal superalloy.

Clause 2B. The system of clause 1B, wherein the single crystal superalloy comprises a single crystal nickel-based superalloy.

Clause 3B. The system of clause 2B, wherein the single crystal nickel-based superalloy comprises about 5.5 weight percent (wt. %) to about 7.5 wt. % chromium, about 8 wt % to about 11 wt % cobalt, and about 5 wt. % to about 7 wt % tungsten.

Clause 4B. The system of clause 3B, wherein the single crystal nickel-based superalloy comprises about 9 wt % to about 11 wt % cobalt.

Clause 5B. The system of clauses 3B or 4B, wherein the single crystal nickel-based superalloy further comprises about 0.3 wt % to about 0.9 wt % molybdenum, about 0.5 wt % to about 1.5 wt % titanium, about 5.5 wt % to about 7.5 wt % tantalum, about 5.0 wt % to about 6 wt. % aluminum, about 2 wt % to about 4 wt % rhenium, and up to about 0.5 wt % hafnium with a remainder being nickel.

Clause 6B. The system of clause 5B, wherein the single crystal nickel-based superalloy comprises about 5.5 wt % to about 6.5 wt % tantalum.

Clause 7B. The system of any one of clauses 1B to 6B, wherein the system is in accordance with any one of clauses 1A to 15A.

Clause 8B. A method in accordance with clause 18A, performed with a system in accordance with any one of clauses 1B to 7B.

Clause 1C. A pulsed electrochemical machining (pECM) system, comprising: an pECM tool comprising a tool body, the tool body comprising an electrode defining a working surface configured to oppose a workpiece during a pECM process; an electrolyte system configured to supply electrolyte to an interelectrode gap between the working surface of the electrode and a target surface of the workpiece; and a power supply configured to generate a pulsed direct current between the one or more electrodes of the pECM tool and the workpiece during the pECM process, wherein the electrode comprises an oxidation resistant layer defining at least a portion of the working surface, the oxidation resistant layer comprising at least one of titanium oxide, iridium oxide, platinum, or gold, and wherein the workpiece comprises a single crystal nickel-based superalloy and is a subcomponent for fabrication into high pressure turbine blades and vanes, wherein the single crystal nickel-based superalloy comprises about 5.5 weight percent (wt. %) to about 7.5 wt. % chromium, about 8 wt % to about 11 wt % cobalt, and about 5 wt. % to about 7 wt % tungsten, and wherein the single crystal nickel-based superalloy further comprises about 0.3 wt % to about 0.9 wt % molybdenum, about 0.5 wt % to about 1.5 wt % titanium, about 5.5 wt % to about 7.5 wt % tantalum, about 5.0 wt % to about 6 wt. % aluminum, about 2 wt % to about 4 wt % rhenium, and up to about 0.5 wt % hafnium with a remainder being nickel.

Clause 2C. A method in accordance with any of the clause described herein, performed by the system of clause 1C.

Clause 1D. A pulsed electrochemical machining (pECM) system, comprising: an pECM tool comprising a tool body, the tool body comprising an electrode defining a working surface configured to oppose a workpiece during a pECM process; an electrolyte system configured to supply electrolyte to an interelectrode gap between the working surface of the electrode and a target surface of the workpiece; and a power supply configured to generate a pulsed direct current between the one or more electrodes of the pECM tool and the workpiece during the pECM process, wherein the electrode comprises an oxidation resistant layer defining at least a portion of the working surface, the oxidation resistant layer comprising at least one of titanium oxide, iridium oxide, platinum, or gold, and wherein the workpiece comprises a single crystal nickel-based superalloy and is a subcomponent for fabrication into high pressure turbine blades and vanes, wherein the single crystal nickel-based superalloy comprises about 5.5 weight percent (wt. %) to about 7.5 wt. % chromium, about 8 wt % to about 11 wt % cobalt, and about 5 wt. % to about 7 wt % tungsten.

Clause 2D. The pECM system of clause 1D, wherein the single crystal nickel-based superalloy further comprises about 0.3 wt % to about 0.9 wt % molybdenum, about 0.5 wt % to about 1.5 wt % titanium, about 5.5 wt % to about 7.5 wt % tantalum, about 5.0 wt % to about 6 wt. % aluminum, about 2 wt % to about 4 wt % rhenium, and up to about 0.5 wt % hafnium with a remainder being nickel.

Clause 3D. A method in accordance with any of the clause described herein, performed by the system of clause 1D or 2D.

Clause 1E. A pulsed electrochemical machining (pECM) system, comprising: an pECM tool comprising a tool body, the tool body comprising an electrode defining a working surface configured to oppose a workpiece during a pECM process; an electrolyte system configured to supply electrolyte to an interelectrode gap between the working surface of the electrode and a target surface of the workpiece; and a power supply configured to generate a pulsed direct current between the one or more electrodes of the pECM tool and the workpiece during the pECM process, wherein the electrode comprises: an oxidation resistant layer defining at least a portion of the working surface, and a diamond-like carbon coating that defines another surface of the electrode.

Clause 2E. The system of clause 1E, wherein the electrode includes a base member including a conductive material, wherein the diamond-like carbon coating overlays at least a portion of the base member, and wherein the diamond-like carbon coating is configured to reduce oxidation of conductive material of the base member while the electrode functions as an anode during the pECM process.

Clause 3E. The system of clause 1E or clause 2E, wherein the diamond-like carbon coating is an electrical insulator such that the diamond-like carbon coating exhibits an electrical conductivity less than that of the oxidation resistant layer.

Clause 4E. The system of any one of clauses 1E-3E, wherein the power supply is configured to generate the pulsed direct current between the electrode of the pECM tool and the workpiece during the pECM process with the electrode being an anode during a first portion of the process and being a cathode during a second portion of the pECM process.

Clause 5E. The system of any one of clauses 1E-4E, wherein the oxidation resistant layer comprises platinum.

Clause 6E. The system of any one of clauses 1E-5E, wherein the oxidation resistant layer comprises the metal oxide, and wherein the metal oxide includes iridium oxide.

Clause 7E. The system of any one of clauses 1E-6E, wherein oxidation resistant layer defines only a first portion of the working surface, and the diamond-like carbon coating that defines a second portion of the working surface of the electrode.

Clause 8E. The system of clause 7E, wherein the first portion of the working surface defines a face of the electrode and the second portion defines sides of the electrodes adjacent to the face.

Clause 9E. The system of any one of clauses 1E-8E, further comprising a mechanical system configured to oscillate a position the working surface of the electrode relative to the workpiece during the pECM process.

Clause 10E. A pulsed electrochemical machining (pECM) tool, comprising: a tool body defining a tool axis, the tool body comprising an electrode defining a working surface configured to face a workpiece, wherein the electrode comprises: an oxidation resistant layer defining at least a portion of the working surface, and a diamond-like carbon coating that defines another surface of the electrode.

Clause 11E. The pECM tool of clause 10E, wherein the electrode includes a base member including a conductive material, wherein the diamond-like carbon coating overlays at least a portion of the base member, and wherein the diamond-like carbon coating is configured to reduce oxidation of conductive material of the base member while the electrode functions as an anode during the pECM process.

Clause 12E. The pECM tool of clause 10E or clause 11E, wherein the diamond-like carbon coating is an electrical insulator such that the diamond-like carbon coating exhibits an electrical conductivity less than that of the oxidation resistant layer.

Clause 13E. The pECM tool of any one of clauses 10E-12E, wherein the oxidation resistant layer comprises platinum.

Clause 14E. The pECM tool of any one of clauses 10E-13E, wherein the oxidation resistant layer comprises the metal oxide, and wherein the metal oxide includes iridium oxide.

Clause 15E. The pECM tool of any one of clauses 10E-14E, wherein oxidation resistant layer defines only a first portion of the working surface, and the diamond-like carbon coating that defines a second portion of the working surface of the electrode.

Clause 16E. The pECM tool of clause 15E, wherein the first portion of the working surface defines a face of the electrode and the second portion defines sides of the electrodes adjacent to the face.

Clause 17E. A method for pulsed electrochemical machining (pECM) a workpiece, comprising: generating a pulsed direct current between an electrode of a machining tool and the workpiece, electrode defining a working surface configured to oppose a workpiece during a pECM process, wherein the electrode comprises: an oxidation resistant layer defining at least a portion of the working surface, and a diamond-like carbon coating that defines another surface of the electrode; delivering an electrolyte into an interelectrode gap between the working surface of the electrode and a target surface of the workpiece; and positioning the working surface of the one or more electrodes relative to the target surface of the workpiece to remove material from the target surface of the workpiece.

Clause 18E. The method of clause 17E, wherein the electrode includes a base member including a conductive material, wherein the diamond-like carbon coating overlays at least a portion of the base member, and wherein the diamond-like carbon coating is configured to reduce oxidation of conductive material of the base member while the electrode functions as an anode during the pECM process.

Clause 19E. The method of clause 17E or 18E, wherein the diamond-like carbon coating is an electrical insulator such that the diamond-like carbon coating exhibits an electrical conductivity less than that of the oxidation resistant layer.

Clause 20E. The method of any one of clauses 17E-19E, wherein generating a pulsed direct current between an electrode of a machining tool and the workpiece comprises generating the pulsed direct current between the electrode of the pECM tool and the workpiece during the pECM process with the electrode being an anode during a first portion of the process and being a cathode during a second portion of the pECM process.

Clause 21E. The method of any one of clauses 17E-20E, wherein the oxidation resistant layer comprises platinum.

Clause 22E. The method of any one of clauses 17E-21E, wherein the oxidation resistant layer comprises the metal oxide, and wherein the metal oxide includes iridium oxide.

Clause 23E. The method of any one of clauses 17E-22E, wherein oxidation resistant layer defines only a first portion of the working surface, and the diamond-like carbon coating that defines a second portion of the working surface of the electrode.

Clause 24E. The method of clause 23E, wherein the first portion of the working surface defines a face of the electrode and the second portion defines sides of the electrodes adjacent to the face.

Clause 25E. The method of any one of clauses 17E-24E, further comprising oscillating a position the working surface of the electrode relative to the workpiece during the pECM process.

Clause 1F: A pulsed electrochemical machining (pECM) system, comprising: an pECM tool comprising a tool body, the tool body comprising an electrode defining a working surface configured to oppose a workpiece during a pECM process; an electrolyte system configured to supply electrolyte to an interelectrode gap between the working surface of the electrode and a target surface of the workpiece; and a power supply configured to generate a pulsed direct current between the one or more electrodes of the pECM tool and the workpiece during the pECM process, wherein the electrode comprises: an oxidation resistant layer defining at least a portion of the working surface, and an electrically insulative coating that defines another surface of the electrode, the electrically insulative coating being less electrically conductive than the oxidation resistant layer.

Clause 2F: The pECM system of clause 1F, wherein the tool is in accordance with any of clauses 1E-16E.

Clause 3F: A method in accordance with any one of clauses 17E-24E, performed by the pECM system of any one of clauses 1F or 2F.

1. A pulsed electrochemical machining (pECM) system, comprising:
an pECM tool comprising a tool body, the tool body comprising an electrode defining a working surface configured to oppose a workpiece during a pECM process;
an electrolyte system configured to supply electrolyte to an interelectrode gap between the working surface of the electrode and a target surface of the workpiece; and
a power supply configured to generate a pulsed direct current between the one or more electrodes of the pECM tool and the workpiece during the pECM process,
wherein the electrode comprises:
an oxidation resistant layer defining at least a portion of the working surface, and
a diamond-like carbon coating that defines another surface of the electrode.

2. The system of claim 1, wherein the electrode includes a base member including a conductive material, wherein the diamond-like carbon coating overlays at least a portion of the base member, and wherein the diamond-like carbon coating is configured to reduce oxidation of conductive material of the base member while the electrode functions as an anode during the pECM process.

3. The system of claim 1, wherein the diamond-like carbon coating is an electrical insulator such that the diamond-like carbon coating exhibits an electrical conductivity less than that of the oxidation resistant layer.

4. The system of claim 1, wherein the power supply is configured to generate the pulsed direct current between the electrode of the pECM tool and the workpiece during the pECM process with the electrode being an anode during a first portion of the process and being a cathode during a second portion of the pECM process.

5. The system of claim 1, wherein the oxidation resistant layer comprises platinum.

6. The system of claim 1, wherein the oxidation resistant layer comprises the metal oxide, and wherein the metal oxide includes iridium oxide.

7. The system of claim 1, wherein oxidation resistant layer defines only a first portion of the working surface, and the diamond-like carbon coating that defines a second portion of the working surface of the electrode.

8. The system of claim 7, wherein the first portion of the working surface defines a face of the electrode and the second portion defines sides of the electrodes adjacent to the face.

9. The system of claim 1, further comprising a mechanical system configured to oscillate a position the working surface of the electrode relative to the workpiece during the pECM process.

10. A pulsed electrochemical machining (pECM) tool, comprising:
a tool body defining a tool axis, the tool body comprising an electrode defining a working surface configured to face a workpiece, wherein the electrode comprises:
an oxidation resistant layer defining at least a portion of the working surface, and
a diamond-like carbon coating that defines another surface of the electrode.

11. The pECM tool of claim 10, wherein the electrode includes a base member including a conductive material, wherein the diamond-like carbon coating overlays at least a portion of the base member, and wherein the diamond-like carbon coating is configured to reduce oxidation of conductive material of the base member while the electrode functions as an anode during the pECM process.

12. The pECM tool of claim 10, wherein the diamond-like carbon coating is an electrical insulator such that the diamond-like carbon coating exhibits an electrical conductivity less than that of the oxidation resistant layer.

13. The pECM tool of claim 10, wherein the oxidation resistant layer comprises platinum.

14. The pECM tool of claim 10, wherein the oxidation resistant layer comprises the metal oxide, and wherein the metal oxide includes iridium oxide.

15. The pECM tool of claim 10, wherein oxidation resistant layer defines only a first portion of the working surface, and the diamond-like carbon coating that defines a second portion of the working surface of the electrode.

16. The pECM tool of claim 15, wherein the first portion of the working surface defines a face of the electrode and the second portion defines sides of the electrodes adjacent to the face.

17. A method for pulsed electrochemical machining (pECM) a workpiece, comprising:
generating a pulsed direct current between an electrode of a machining tool and the workpiece, electrode defining a working surface configured to oppose a workpiece during a pECM process, wherein the electrode comprises:
an oxidation resistant layer defining at least a portion of the working surface, and
a diamond-like carbon coating that defines another surface of the electrode;
delivering an electrolyte into an interelectrode gap between the working surface of the electrode and a target surface of the workpiece; and
positioning the working surface of the one or more electrodes relative to the target surface of the workpiece to remove material from the target surface of the workpiece.

18. The method of claim 17, wherein the electrode includes a base member including a conductive material, wherein the diamond-like carbon coating overlays at least a portion of the base member, and wherein the diamond-like carbon coating is configured to reduce oxidation of conductive material of the base member while the electrode functions as an anode during the pECM process.

19. The method of claim 17, wherein the diamond-like carbon coating is an electrical insulator such that the diamond-like carbon coating exhibits an electrical conductivity less than that of the oxidation resistant layer.

20. The method of claim 17, wherein generating a pulsed direct current between an electrode of a machining tool and the workpiece comprises generating the pulsed direct current between the electrode of the pECM tool and the workpiece during the pECM process with the electrode being an anode during a first portion of the process and being a cathode during a second portion of the pECM process.
